(19) United States
(12) Patent Application Publication
(10) Pub. No.: US 2014/0106951 A1
(43) Pub. Date: Apr. 17, 2014

(54) METHODS AND SYSTEMS FOR SECURING A SLEEVE FOR ENDOLUMINAL DEVICES

(71) Applicant: W. L. Gore & Associates, Inc., Newark, DE (US)

(72) Inventor: Kevin S. Brandon, Flagstaff, AZ (US)

(73) Assignee: W. L. Gore & Associates, Inc., Newark, DE (US)

(21) Appl. No.: 14/053,433

(22) Filed: Oct. 14, 2013

Related U.S. Application Data
(60) Provisional application No. 61/713,998, filed on Oct. 15, 2012.

(51) Int. Cl. B31D 5/00

(52) U.S. Cl. CPC B31D 5/0086
USPC 493/384

(57) ABSTRACT

The present disclosure describes methods and apparatus for preparing a sleeve used to surround and assist in delivering an expandable implant to the vasculature of a human patient. The sleeve is formed by curving a sheet of material, longitudinally folding the material, and securing the longitudinally folded material with an elongated member, such as wire or thread, to form a sleeve. The resulting sleeve can then receive an endoluminal device.

### FIELD

The present disclosure relates generally to sleeves for endoluminal devices and, more specifically, to securing a sleeve for surrounding endoluminal devices to be delivered to the vasculature of a patient.

### BACKGROUND

Endoluminal devices are frequently used to treat the vasculature of human patients. Devices such as grafts, stents, filters, and other implantable devices are often delivered to vasculature using a delivery catheter. To facilitate delivery to the vasculature of the patient, endoluminal devices often have a smaller delivery diameter and an expanded working diameter. Sleeves surrounding endoluminal devices may serve to compress an endoluminal device from the expanded diameter to the smaller diameter and/or surround the endoluminal device to maintain it in the compressed state until it is delivered to the site in the vasculature at which it will be expanded. In addition, or in the alternative, sleeves surrounding endoluminal devices may serve to cover or protect the endoluminal device before and during delivery. It is thus desirable to provide methods and systems for manufacturing sleeves for use with endoluminal devices.

### BRIEF DESCRIPTION OF THE DRAWINGS

The accompanying drawings are included to provide a further understanding of the disclosure and are incorporated in and constitute a part of this specification, illustrate embodiments of the disclosure, and together with the description, serve to explain the principles of the disclosure, wherein:

FIG. 1 illustrates a perspective view a of constraining sleeve;

FIGS. 2A, 2B, and 2C illustrate a top view, a perspective view, and a side view, respectively, of a constraining sleeve in various stages of preparation;

FIGS. 3A, 3B, 3C, and 3D illustrate a perspective view and three side views, respectively, of various sleeves;

FIGS. 4A, 4B, and 4C illustrate a perspective view of a constraining sleeve securing device and two side views of an introducing section, a folding section and a threading section of a constraining sleeve securing device; and

FIGS. 5A and 5B illustrate a side view and perspective view, respectively, of a longitudinally folded material.

### DETAILED DESCRIPTION OF THE ILLUSTRATED EMBODIMENTS

Persons skilled in the art will readily appreciate that various aspects of the present disclosure can be realized by any number of methods and systems configured to perform the intended functions. Stated differently, other methods and systems can be incorporated herein to perform the intended functions. It should also be noted that the accompanying drawing figures referred to herein are not all drawn to scale, but can be exaggerated to illustrate various aspects of the present disclosure, and in that regard, the drawing figures should not be construed as limiting. Finally, although the present disclosure can be described in connection with various principles and beliefs, the present disclosure should not be bound by theory.

In various embodiments, a sleeve for covering or protecting an endoluminal device, compressing an endoluminal device, and/or maintaining an endoluminal device in a compressed state (any of the foregoing referred to herein as a “constraining sleeve” or a “sleeve”) is formed by curving a sheet of material such that one edge is proximate another edge, such that the general shape of a constraining sleeve is formed. As described in connection with the various embodiments disclosed herein, the curved material is then flattened, after which it is longitudinally folded to create a plurality of longitudinal folds. A plurality of holes is created in the longitudinal folds. The holes are then used to receive an elongated member, such as a thread or wire to secure the curved material in the configuration of a constraining sleeve.

As described in more detail below, various embodiments of a device used to create a constraining sleeve comprise an introducing section, a folding section, and a threading section. In accordance with various embodiments of the disclosure, the introducing section comprises one or more mechanisms which receive, orient and at least partially flatten the curved sheet of material. The folding section comprises one or more mechanisms which longitudinally fold the curved, flattened sheet of material creating a plurality of longitudinal folds without introducing significant stresses and strains in the material as it is folded. In accordance with various embodiments of the disclosure, the threading section comprises one or more mechanisms which create a plurality of holes in the longitudinal folds and which may facilitate the threading of the holes with an elongated member. In the context of this disclosure, “elongated member” can mean any member, such as, for example, a metal, organic, synthetic, and/or polymeric thread or wire, which can suitably secure a material and can be biocompatible.

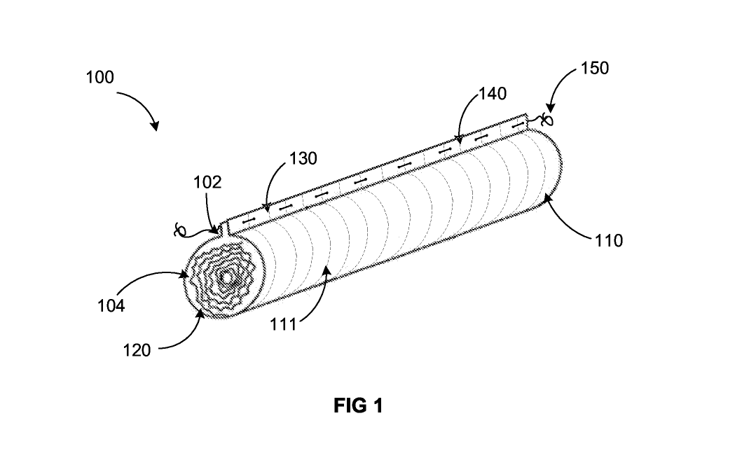

With reference to FIG. 1, an embodiment of a constraining sleeves 100 in accordance with the present disclosure are illustrated. Constraining sleeve 100 comprises a sheet of material 110, curved to create a lumen 120 in the general shape of constraining sleeve 100 by locating edges 102 of material 110 proximate one another. A plurality of holes 130 aligned in the edges 102 proximate one another allow an elongated member 140 to be passed therethrough to secure constraining sleeve 100 in its desired configuration. Elongated member 140 may be secured by one or more knots 150. Constraining sleeve 100 thus formed may be used to cover, protect, compress and/or maintain compressed an endoluminal device 104, and upon delivery to a treatment site, elongated member 140 may be removed, allowing the removal of constraining sleeve 100 from endoluminal device 104.

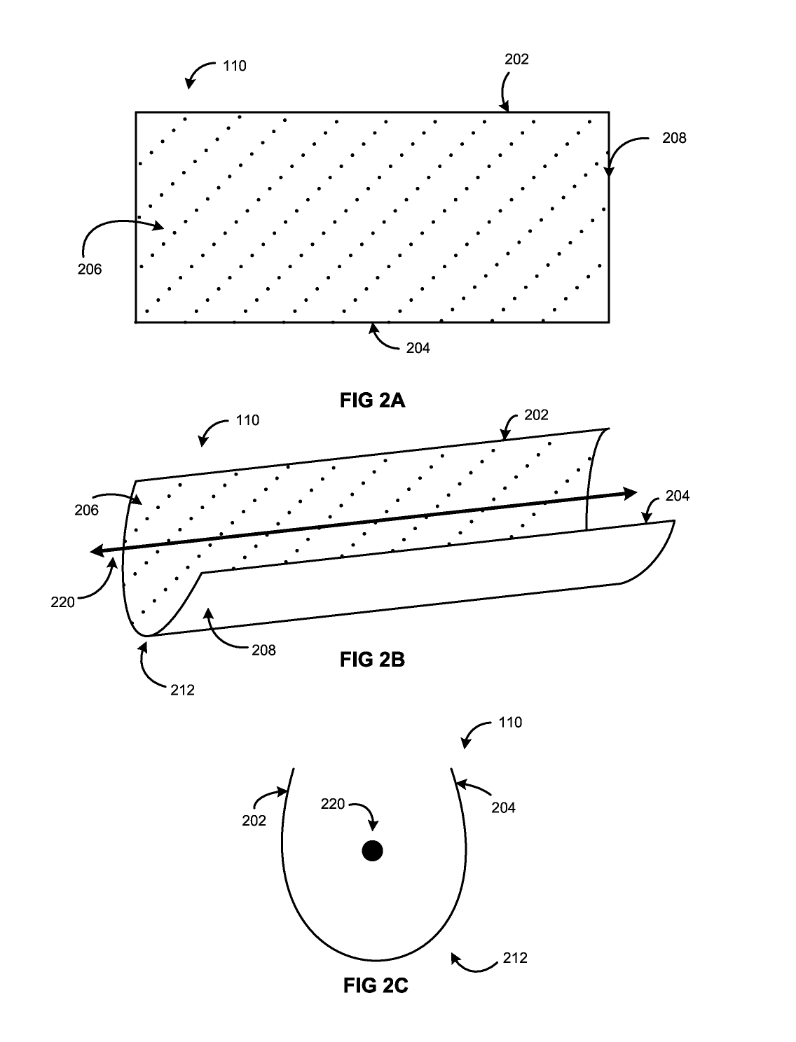

With reference to FIG. 2A, material 110 in accordance with the present disclosure comprises a top surface 206, a bottom surface 208, a first longitudinal edge 202, and a second longitudinal edge 204. Material 110 can comprise a biocompatible material, such as, for example, expanded polytetrafluoroethylene (ePTFE), polyester, polyurethane, fluoropolymers, such as perfouorelastomers and the like, polytetrafluoroethylene, silicones, urethanes, ultra high molecular weight polyethylene, aramid fibers, and combinations thereof. In various embodiments, material 110 can include high strength polymer fibers such as ultra high molecular weight polyethylene fibers (e.g., Spectra®, Dyneema Purity®, etc.) or aramid fibers (e.g., Technora®, etc.).

Material 110 can include a bioactive agent. For example, material 110 can be coated by a therapeutic agent such as, for example, heparin, sirolimus, paclitaxel, everolimus, ABT-578, mycophenolic acid, tacrolimus, estradiol, oxygen free radical scavenger, biolimus A9, anti-CD34 antibodies, PDGF receptor blockers, MMP-1 receptor blockers, VEGF, G-CSF, HMG-CoA reductase inhibitors, stimulators of iNOS and eNOS, ACE inhibitors, ARBs, doxycycline, thalidomide, and many others. The use of any therapeutic coating which can be applied to material 110 is within the scope of the present disclosure.

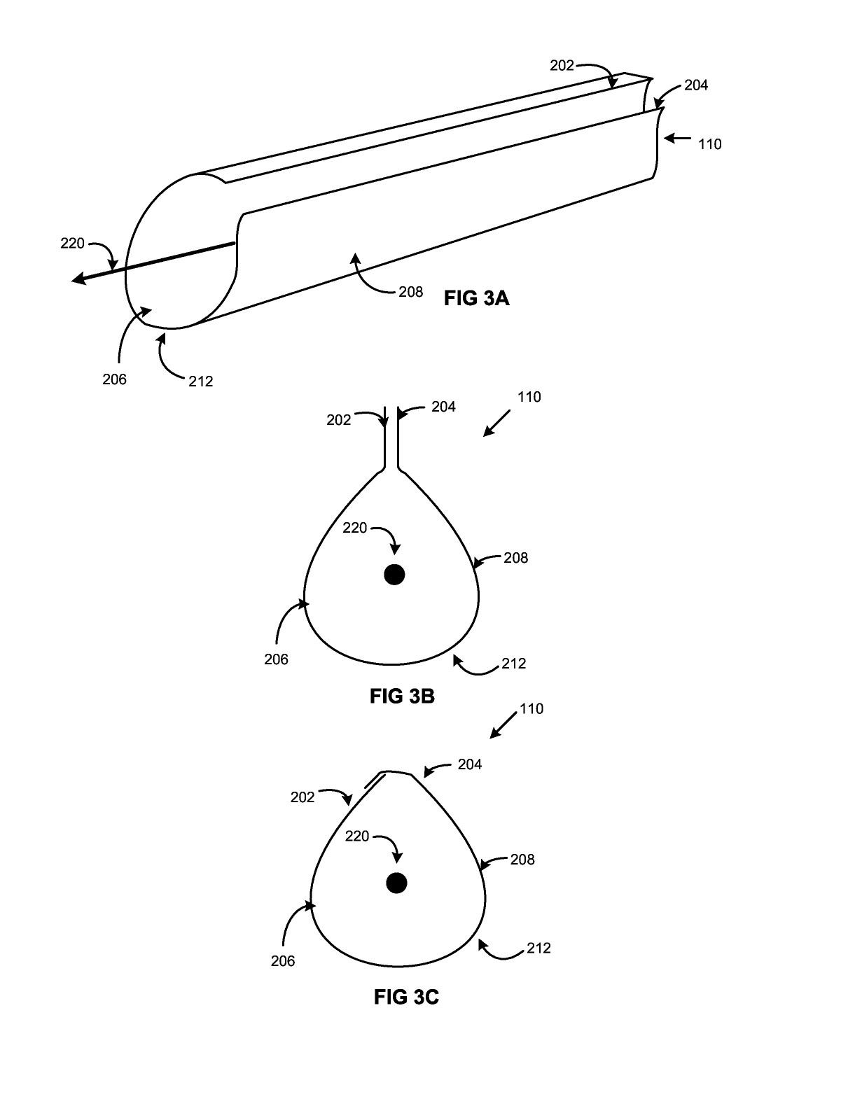

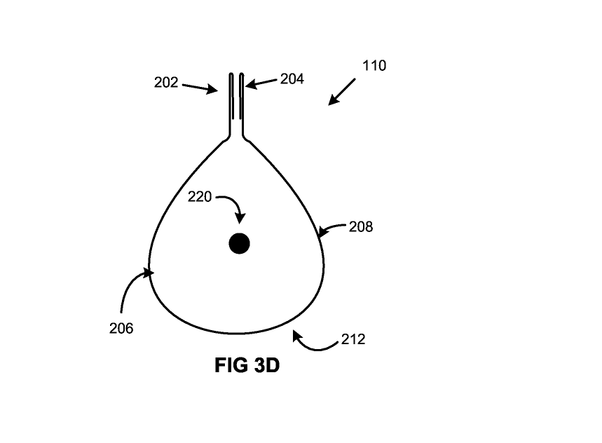

With reference to FIGS. 2B, 2C, 3A, 3B, 3C, and 3D material 110 can be curved to form the general shape of constraining sleeve 100. Sleeve 100 can be formed, for example, by curving material 110 such that first longitudinal edge 202 and second longitudinal edge 204 are aligned substantially parallel to each other and top surface 206 is adjacent to and/or in contact with itself and creating a curved portion 212, as illustrated in FIG. 3B. Alternatively, as illustrated in FIG. 3C, sleeve 100 can be formed by curving material 110 such that first longitudinal edge 202 and second longitudinal edge 204 are aligned substantially parallel to each other, and top surface 206 overlaps bottom surface 208, or vice versa.

In other embodiments, as illustrated in FIG. 3D, sleeve 100 can be formed by curving material 110 such that first longitudinal edge 202 and second longitudinal edge 203 are aligned substantially parallel to each other, and bottom surface 208 is adjacent to and/or in contact with itself. However, any manner of curving material 110 such that it creates a sleeve 100 is within the scope of the present disclosure. Material 110 can then be processed using various embodiment of devices such as those disclosed herein to form a constraining sleeve for covering, protecting, compressing, and/or maintaining an endoluminal device in a compressed state.

As described in additional detail below, constraining sleeves such as those described above can be formed by a sleeve securing device. For example, the sleeve securing device can comprise an introducing section, a folding section, and a threading section. In such embodiments, curved material such as noted above is initially placed in the introducing section, advanced through the folding section to create a plurality of folds (designated as reference numeral 111 in FIG. 1), and advanced through the threading section to create the above-noted holes and optionally, to thread and secure curved material as a constraining sleeve.

The introducing section of the sleeve securing device can be configured to receive, orient and at least partially flatten the curved sheet of material. In such configurations, opposing edges of the curved material are placed within a guide, such as, for example, a channel, pathway, or a slot, which helps maintain the material in the above-noted noted curved configuration. The material is then advanced to the folding section of the device.

The folding section of the sleeve securing device can be configured to create a plurality of alternating longitudinal folds (e.g., accordion folds 111) in the material by, for example, advancing the curved, flattened sheet of material through a pair of opposing rollers having a plurality of roller teeth. In such embodiments, each fold is comprised of two or more layers of the material by virtue of the material being curved such that one longitudinal edge is proximate another longitudinal edge. The roller teeth may create the plurality of longitudinal folds at an angle to a longitudinal axis (e.g., axis 220 of FIG. 2B) of the material such as perpendicular or at other angles. The curved, flattened material may thus be folded without unduly stretching, stressing, or straining the material, and can reduce or prevent failure of the material.

In various exemplary embodiments, folds 111 are temporary folds which do not permanently fold or crease material 110. For example, in FIG. 1, folds 111 are temporary folds created by two opposing rollers. Folds 111 are illustrated in phantom lines to indicate their position relative to lumen 120, holes 130, and elongated member 140. After sleeve 100 is formed, folds 111 may not be visible, or may be visible only as slight creases in material 110.

As the longitudinal folds are formed in the material, they are advanced to the threading section. The threading section may be configured as within, partially within, or exterior to the folding section. The threading section can use a threading element, such as a hollow needle, to puncture the material at each fold, creating a plurality of corresponding holes proximate the edges of the material. After the material has been punctured to create the plurality of holes, an elongated member can be passed through the holes. A constraining sleeve is thus formed by securing the elongated member by, for example, tying it in one or more knots.

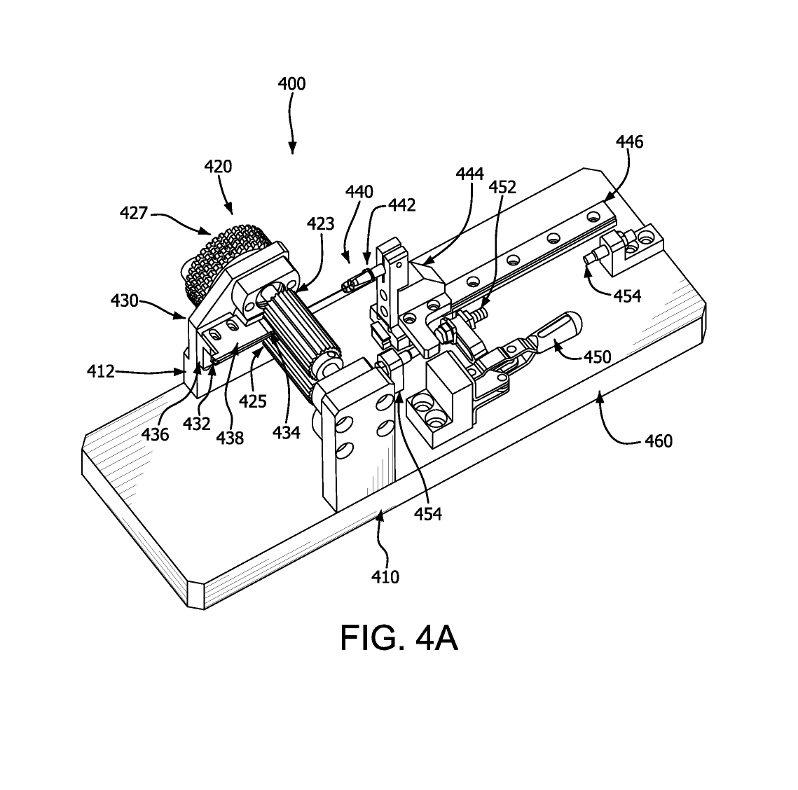

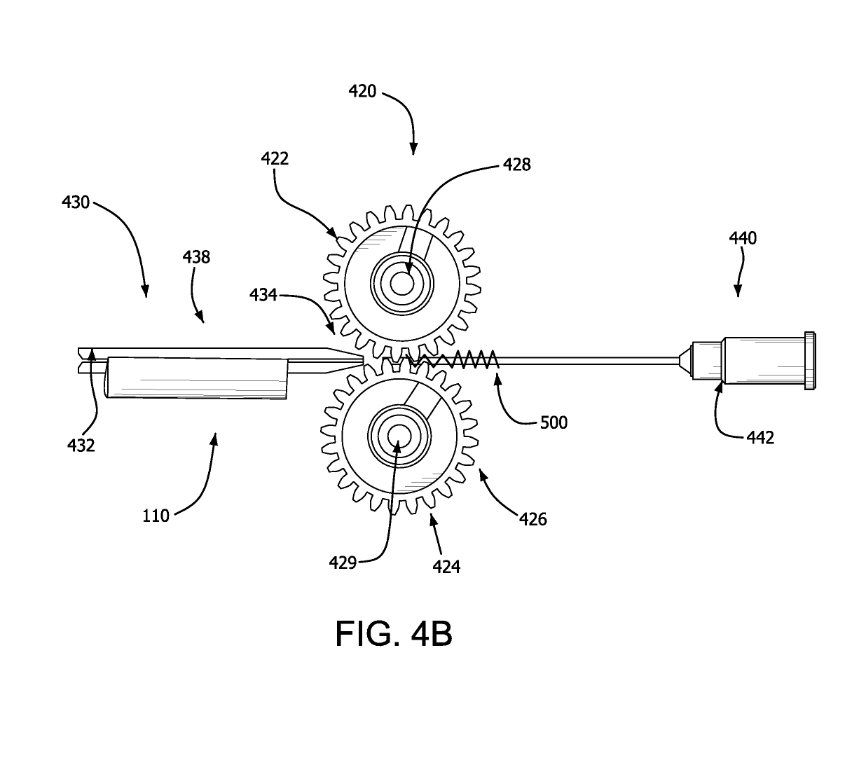

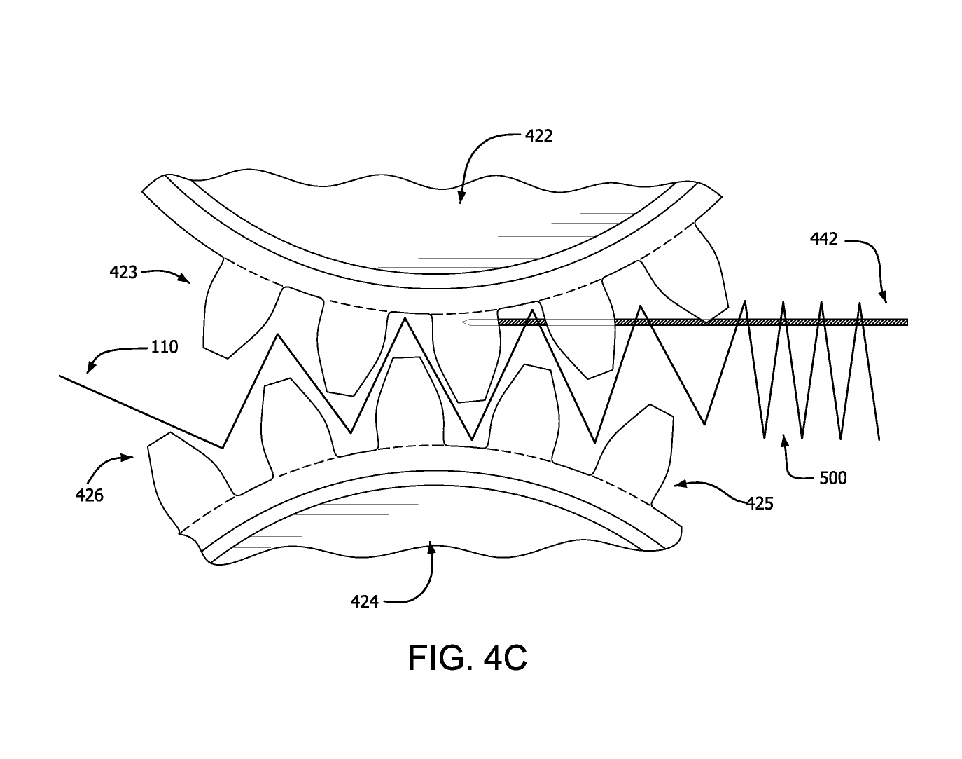

With reference now to FIG. 4A, an embodiment of a sleeve securing device 400 in accordance with the present disclosure comprises an introducing section 430, a folding section 420, and a threading section 440. In various embodiments, any of introducing section 430, folding section 420, and threading section 440 are removably coupled to base 460 or any suitable support or stanchion by, for example, threaded fasteners, clamps, bolts, screws, pins, press-fitting, magnetism, or any other suitable method of removably coupling. In other embodiments, various sections can be permanently coupled to base 460 or any suitable support or stanchion by, for example, welding or casting, or any other suitable method of permanently coupling.

As described above, in various embodiments, introducing section 430 is configured to receive a material 110 which has been curved such that one edge 202 is proximate another edge 204 as described above. In such configurations, introducing section 430 receives material 110 and orients and at least partially flattens it so that it may be advanced to folding section 420.

In this regard, as illustrated in FIGS. 4A and 4B, introducing section 430 can include a material guide 438. Material guide 438 can be configured to maintain material 110 in the curved configuration. In some embodiments, material guide 438 includes an entry slot 432. In various embodiments, entry slot 432 is configured in a “C-channel” shape, such that material 110 can be inserted into entry slot 432 lengthwise. In various embodiments, material 110 is inserted into entry slot 432 in a curved configuration such that first longitudinal edge 202 and second longitudinal edge 204 are generally parallel and maintained in proximity to each other. In this manner, the edges 202 and 204 of material 110 are inserted into entry slot 432, and curved portion 212 of material 110 is in proximity to the open portion of the channel of entry slot 432.

Once positioned in entry slot 432, material 110 can be advanced through material guide 438 to an exit slot 434. Similarly to entry slot 432, exit slot 434 can comprise a C-channel shape, such that material 110 traverses exit slot 434 lengthwise. Exit slot 434 can be configured to properly orient and/or flatten material 110 as it is advanced to folding section 420.

As noted previously, introducing section 430 can be coupled to base 460 in various manners. In an embodiment, material guide 438 can be removably or permanently coupled to a folding section support 436. Folding section support 436 can in turn be removably coupled to base 460 or any suitable support or stanchion by, for example, threaded fasteners, clamps, bolts, screws, pins, press-fitting, magnetism, or any other suitable method of removably coupling. Alternatively, folding section support 436 can be permanently coupled to base 460 or any suitable support or stanchion by, for example, welding or casting, or any other suitable method of permanently coupling.

In various embodiments, folding section 420 is located proximate introducing section 430 and is configured to receive material 110 from introducing section 430. As described above, folding section 420 can be configured to create a longitudinally folded material with a plurality of alternating longitudinal folds at an angle to the longitudinal axis 220 of material 110. As noted above, the angle may be generally perpendicular, though in some embodiments, other angles may be desirable.

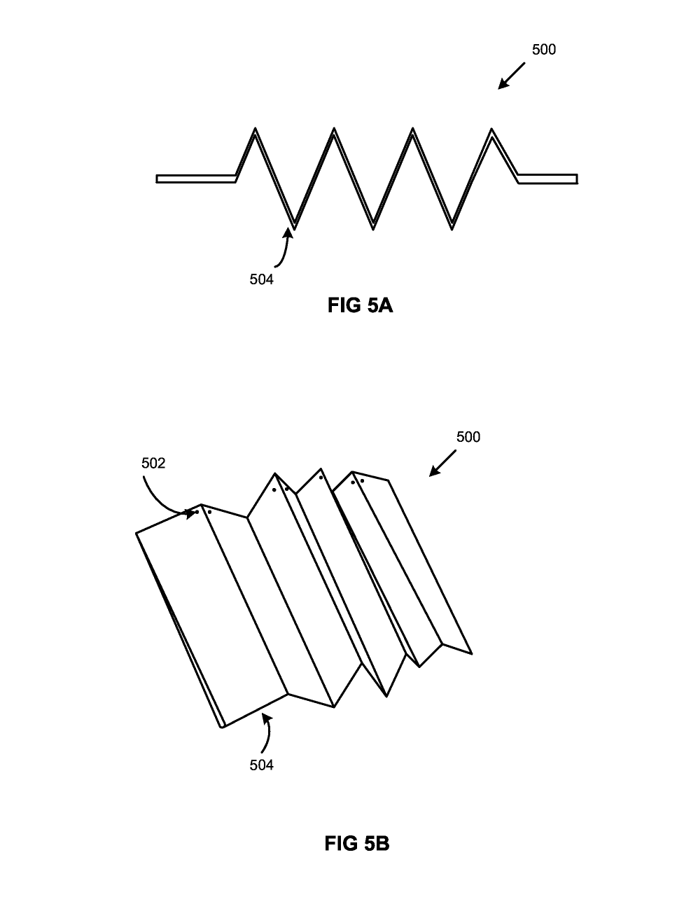

For example, as material 110 is advanced through folding section 420, a longitudinally folded material is formed. With reference to FIGS. 5A and 5B, in various embodiments, a longitudinally folded material 500 comprises a plurality of alternating longitudinal folds 504, such that material 110 is folded in alternating directions in an accordion fashion. In such embodiments, each fold is comprised of two layers of material 110 by virtue of the material being curved such that one longitudinal edge is proximate another longitudinal edge.

With reference now to FIGS. 4B and 4C, folding section 420 can comprise a pair of opposing rollers, such as a first roller 422 and a second roller 424. In such configurations, first roller 422 and second roller 424 form a longitudinally folded material 500 by creating a plurality of alternating longitudinal folds 504 as material 110 travels through the rollers 422, 424. However, any method or system of forming a longitudinally folded material 500 is within the scope of the present disclosure.

First roller 422 and second roller 424 can comprise, for example, cylindrically-shaped rollers. In other embodiments, rollers 422 and 424 comprise substantially cone shaped rollers. Any shape and size of first roller 422 and second roller 424 that can form alternating longitudinal folds 504 in material 110 is within the scope of the present disclosure.

In various embodiments, first roller 422 and second roller 424 are positioned generally along parallel rotational axes. First roller 422 can be rotated along a first rotational axis 428. Second roller 424 can be rotated along a second rotational axis 429, for example, in the opposite direction of first roller 422. In some embodiments, as first roller 422 and second roller 424 are rotated, material 110 is pulled through folding section 420.

Referring back to FIG. 4A, in various embodiments, one of first roller 422 and second roller 424 can be rotated by a crank 427, and the roller that is cranked in turn is operable to rotate the other roller. Crank 427 can be a manual crank which is operated by a user physically rotating the crank. Crank 427 can be an automatic crank powered by, for example, an electric motor, including one with a constant or variable speed. Any manner of rotating crank 427, and thereby rotating first roller 422 and second roller 424, is within the scope of the present disclosure.

With reference again to FIGS. 4B and 4C, in various embodiments, first roller 422 and second roller 424 each comprise a plurality of roller teeth 426. In such configurations, as material 110 is advanced through folding section 420, roller teeth 426 of first roller 422 and second roller 424 create the alternating longitudinal folds 504 of longitudinally folded material 500.

The spacing of roller teeth 426 on first roller 422 and second roller 424 can vary. For example, roller teeth 426 can be evenly spaced apart, creating symmetrical and evenly spaced longitudinal folds 504 in material 110. In other embodiments, roller teeth 426 can be unevenly spaced apart, such that longitudinal folds 504 vary in size and spacing. In general, any spacing of roller teeth 426 which creates suitable longitudinal folds 504 is within the scope of the present disclosure.

The size and shape of roller teeth 426 can also vary. For example, all of roller teeth 426 can comprise the same size and shape. This configuration would create symmetrical longitudinal folds 504 in material 110. In other embodiments, the size and/or shape of roller teeth 426 can vary, creating longitudinal folds 504 that vary in size and shape. In general, any size and shape of roller teeth 426 which creates suitable longitudinal folds 504 is within the scope of the present disclosure.

In various embodiments first roller 422 comprises a first notch 423. First notch 423 can be configured to allow a threading element, such as a needle or shaft, to pass through first notch 423 as first roller 422 rotates. In various embodiments, second roller 424 can comprise a second notch 425. Similarly to first notch 423, second notch 425 can be configured to allow a threading element to pass through it as second roller 424 rotates.

As noted previously, folding section 420 can be coupled to base 460. In various embodiments, and with reference back to FIG. 4A, a first roller support 410 and a second roller support 412 can be removably or permanently coupled to first roller 422 and second roller 424, respectively. First roller support 410 and second roller support 412 can in turn be removably coupled to base 460 or any suitable support or stanchion by, for example, threaded fasteners, clamps, bolts, screws, pins, press-fitting, magnetism, or any other suitable method of removably coupling. Alternatively, first roller support 410 and second roller support 412 can be permanently coupled to base 460 or any suitable support or stanchion by, for example, welding or casting, or any other suitable method of permanently coupling.

In various embodiments, as it passes through or after it passes through first roller 422 and second roller 424, longitudinally folded material 500 is advanced to threading section 440. Threading section 440 is configured to create the plurality of holes described above in longitudinally folded material 500, generally proximate edges 202, 204, and may further facilitate the threading of the holes with a thread to form a constraining sleeve.

In this regard, and with reference to both FIGS. 4A, 4B, and 4C, in various embodiments, threading section 440 can include a threading element 442. In such configurations, threading element 442 can comprise a hollow shaft, such as a hypodermic needle. Any threading element which allows an elongated member to pass through it is within the scope of the present disclosure.

In various embodiments, and as better seen in FIGS. 4B and 4C threading element 442 can be configured to pass through first notch 423 of first roller 422 and second notch 425 of second roller 424. In such embodiments, first notch 423 and second notch 425 are aligned such that threading element 442 can pass through both notches while first roller 422 and second roller 424 are rotating.

Turning back to FIG. 4A, in various embodiments, threading element 442 can be coupled to a sled 444. In such configurations, sled 444 can be used to properly position threading element 442 relative to folding section 420 by moving towards and away from folding section 420. Sled 444 can be positioned on a track 446, which allows sled 444 to move longitudinally without moving in other directions.

In various embodiments, track 446 can be coupled to base 460. Track 446 can in turn be removably coupled to base 460 or any suitable support or stanchion by, for example, threaded fasteners, clamps, bolts, screws, pins, press-fitting, magnetism, or any other suitable method of removably coupling. Alternatively, track 446 can be permanently coupled to base 460 or any suitable support or stanchion by, for example, welding or casting, or any other suitable method of permanently coupling.

Threading section 440 can include a first stop 452. First stop 452 is positioned on base 460 to properly position threading element 442 with relation to folding section 420 and prevent threading element 442 from extending too far into folding section 420. Threading section 440 can further include a second stop 454. Second stop 454 is positioned on base 460 to prevent sled 444 from traveling too far away from folding section 420 and potentially disengaging from track 446.

In various embodiments, threading section 440 includes a locking mechanism 450. In such embodiments, when threading element 442 is properly positioned in relation to folding section 420, locking mechanism 450 can be engaged to maintain the position of threading element 442 by, for example, temporarily fixing the position of sled 444 to which threading element 442 is attached. Any configuration of locking mechanism 450 which secures the position of threading element 442 is within the scope of the present disclosure.

With reference to FIG. 5B, as material 110 is folded to create longitudinally folded material 500, threading element 442 can create a plurality of holes 502 in longitudinally folded material 500. In various embodiments, holes 502 are aligned along the length of longitudinally folded material 500, generally proximate edges 202, 204. Holes 502 may be positioned such that each is generally centered between each fold 504 on either side of each hole 502. In other configurations, each hole 502 may be at other positions relative to each fold 504.

In various exemplary embodiments, threading element 442 can engage longitudinally folded material 500 as it passes through first roller 422 and second roller 424, creating plurality of holes 502. As illustrated in FIG. 4B, in such configurations, threading element 442 is positioned within first notch 423 and second notch 425, and as longitudinally folded material 500 progresses through folding section 420, longitudinally folded material 500 can gather on threading element 442.

In various embodiments, an elongated member can be used to secure longitudinally folded material 500. In such embodiments, an elongated member is passed through threading element 442. As threading element 442 is in communication with holes 502, the elongated member passes through holes 502 and emerges from threading element 442 on the far side of longitudinally folded material 500. The elongated member can comprise, for example, ePTFE, polyester, polyurethane, fluoropolymers, such as perfouorelastomers and the like, polytetrafluoroethylene, silicones, urethanes, ultra high molecular weight polyethylene, aramid fibers, or combinations thereof. Any elongated member, such as a metal, synthetic, organic, and/or polymeric thread or wire, which can suitably secure longitudinally folded material 500 and is biocompatible, is within the scope of the present disclosure.

After the elongated member has passed through all of holes 502 of longitudinally folded material 500, locking mechanism 450 can be disengaged and sled 444 can be returned to its initial position. Longitudinally folded material 500 can then be removed from threading element 442, leaving the elongated member threaded through holes 502.

After passing through the plurality of holes 502, the elongated member can be secured, creating a constraining sleeve such as illustrated in FIG. 1. In various embodiments, the elongated member is secured by, for example, tying a knot. However, any manner of suitably securing the elongated member is within the scope of the present disclosure.

After removal from sleeve securing device 400, an endoluminal device can be inserted into the lumen constraining sleeve. For example, with momentary reference to FIG. 1, an endoluminal device 104 can be inserted into lumen 120 of constraining sleeve 100.

It will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

Likewise, numerous characteristics and advantages have been set forth in the preceding description, including various alternatives together with details of the structure and function of the devices and/or methods. The disclosure is intended as illustrative only and as such is not intended to be exhaustive. It will be evident to those skilled in the art that various modifications can be made, especially in matters of structure, materials, elements, components, shape, size and arrangement of parts including combinations within the principles of the disclosure, to the full extent indicated by the broad, general meaning of the terms in which the appended claims are expressed. To the extent that these various modifications do not depart from the spirit and scope of the appended claims, they are intended to be encompassed therein.

What is claimed is:

1. A device for forming a constraining sleeve for surrounding an endoluminal device comprising:
an introducing section configured to receive and position a material with a top side, a bottom side, a first longitudinal edge, and a second longitudinal edge, wherein the first longitudinal edge and the second longitudinal edge are positioned proximate each other,
a folding section comprising a pair of opposing rollers, each roller having a plurality of roller teeth configured to longitudinally fold the material, wherein at least one of the pair of opposing rollers comprises a notch; and
a threading section comprising a threading element, wherein the threading element is configured to interface with the notch of the pair of opposing rollers and is capable of puncturing the material.

2. The device of claim 1, wherein the threading element comprises a hollow needle.

3. The device of claim 1, wherein the pair of opposing rollers are substantially horizontal.

4. The device of claim 1 further comprising an elongated member.

5. The device of claim 4, wherein the elongated member is a metal wire.

6. The device of claim 4, wherein the elongated member is one of ePTFE, polyester, polyurethane, fluoropolymers, perfouorelastomers, polytetrafluoroethylene, silicones, urethanes, ultra high molecular weight polyethylene, aramid fibers, or combinations thereof.

7. The device of claim 1, wherein the material is an ePTFE sheet.

8. The device of claim 1 further comprising a base.

9. The device of claim 8, wherein the introducing section, the folding section, and the threading element are removably coupled to the base.

10. The device of claim 1 further comprising a sled, wherein the threading element is coupled to the sled.

11. A method for forming a constraining sleeve for surrounding an endoluminal device comprising:
loading a material having a top side, a bottom side, a first longitudinal edge, and a second longitudinal edge, wherein the first longitudinal edge and the second longitudinal edge are positioned proximate each other into a device comprising an introducing section configured to receive the material, a pair of opposing rollers, each roller having a plurality of roller teeth and a notch, and a threading element;
advancing the material to the pair of opposing rollers;
rotating the pair of opposing rollers and advancing the material through the pair of opposing rollers to form a longitudinally folded material;
creating a plurality of holes in the longitudinally folded material with the threading element;
passing an elongated member through the plurality of holes; and
securing the elongated member at an end of longitudinally folded material to form a constraining sleeve.

12. The method of claim 11, further comprising curving the material such that the first longitudinal edge and the second longitudinal edge are in contact with each other and substantially parallel.

13. The method of claim 11, further comprising inserting the endoluminal device into the constraining sleeve.

14. The method of claim 11, wherein the pair of opposing rollers are substantially horizontal.

15. The method of claim 11, wherein the threading element is a needle.

16. The method of claim 11, wherein the elongated member is a metal wire.

17. The method of claim 11, wherein the elongated member is one of ePTFE, polyester, polyurethane, fluoropolymers, perfouorelastomers, polytetrafluoroethylene, silicones, urethanes, ultra high molecular weight polyethylene, aramid fibers, or combinations thereof.

18. The method of claim 11, wherein the material is ePTFE.

19. A method of making a sleeve for containing a medical device, the method comprising the steps of:
clamping and advancing the sleeve between rotating meshed teeth of two opposing gears, thereby forming a plurality of folds along an edge of the sleeve; and
piercing the plurality of folds along the edge of the sleeve with an end of a tubular piercing member as the sleeve is advanced.

20. The method as set forth in claim 19, wherein the opposing gears are provided with aligned circumferentially extending grooves, wherein the end of the tubular piercing member is aligned with the grooves.

21. The method as set forth in claim 19, including the step of feeding an elongate member through the tubular piercing member while the plurality of folds along the edge of the sleeve remains disposed on the tubular piercing member.

22. The method as set forth in claim 21, including the step of removing the plurality of folds along the edge of the sleeve from the tubular piercing member, wherein the elongate member remains disposed through the plurality of folds along the edge of the sleeve.
